(19) United States
(12) Patent Application Publication
(10) Pub. No.: US 2003/0004775 A1
(43) Pub. Date: Jan. 2, 2003

(54) Method of simplifying commodity picking

(76) Inventors: Kuang-Shin Lin, Taipei (TW); Jeff Song, Taipei (TW); Cho-Yin Lee, Tianjin (CN)

Correspondence Address: BIRCH STEWART KOLASCH & BIRCH, PO BOX 747, FALLS CHURCH, VA, 22040-0747, US

(21) Appl. No.: 10/183,556

(22) Filed: Jun. 28, 2002

(30) Foreign Application Priority Data
Jun. 29, 2001 (TW) 90115891

(51) Int. Cl. G06F 17/60

(52) U.S. Cl. 705/8

(57) ABSTRACT

A method of simplifying commodity picking management is disclosed. It is applied in a stock management system to provide an optimized good picking procedure in production distribution. The method includes the steps of reading the data after trucks have been scheduled, optimizing at least one storage location, combining storage locations, sorting storage locations according to a good picking path, and printing data in the good picking list.

### BACKGROUND OF THE INVENTION

1. Field of the Invention

The invention pertains to an application in a stock management system and, more particularly, to a method that simplifies goods picking management in a stock management system.

2. Related Art

In a stock management system, fixed stock man supervising fixed materials in a fixed area has the following drawbacks:

1. Operations and maintenance records have to be entered into the system manually. It is not only easy to make mistakes with this method but also time delays are caused.

2. No other people know where certain materials are located if the person who is in charge of them is on vacation.

3. Employees have to be competent in recognizing whether materials are in good condition while picking them.

4. Employees have to be competent in recognizing whether materials are correct while picking them.

5. Inventory records are updated only after all orders of the day are entered.

6. It is impossible to abide by the FIFO (First In First Out) principle.

7. The system cannot determine which company particular materials are originally from.

8. Daily stock checking has to wait until the operation shuts down.

9. There is no reservation function.

Furthermore, conventional picking methods in production-distribution warehousing are tedious and require two fixed stockman. First, the stockman search locations of the goods according to a good picking list. The locations are mainly determined in accordance with good packages and storage location instructions. If goods are picked in the night, dim light increases difficulty in recognizing the goods. Moreover, one type of good may be distributed at several locations. This will increase the length of the good picking path. Also, the same operation may be repeatedly performed. Sometimes, goods are picked repeatedly at the same storage location. The locations of goods may change from time to time, creating a big challenge for the stock management workers' memory. The accuracy of picking required goods is thus lowered, greatly delaying the good picking time.

### SUMMARY OF THE INVENTION

The invention conveniently solves the above drawbacks. A good picking worker only needs to pick an appropriate amount of goods from designated storage locations following a good picking list without recognizing which commodity is in a particular storage location. The order of the storage locations is sorted in accordance with an optimal good picking path, greatly shortening the distance and time.

The simplified commodity picking management method disclosed herein provides an optimal good picking procedure for production distribution in a stock management system. It contains at least the steps of: reading the data in advance after trucks have been scheduled, optimizing at least one storage location, combining the storage locations, sorting according to a good picking path, and printing data in the good picking list.

The object of the invention is to simplify the process of picking goods. Each stock location is optimized before good picking to make the stock locations for the goods on the same truck closer to one another, minimizing the good picking path. This combination of storage locations alleviates the problem of repeatedly picking goods at the same storage location. The storage locations are sorted according to the good picking path, thus minimizing operations back and forth and allowing all goods to be picked at one time. The combination of these three steps greatly increases good picking efficiency.

### BRIEF DESCRIPTION OF THE DRAWINGS

The invention will become more fully understood from the detailed description given hereinbelow. However, the following description is for purposes of illustration only, and thus is not limitative of the invention, wherein:

FIG. 1 is a flowchart of main functions of the invention;

FIG. 2 is a storage location optimization flowchart;

FIG. 3 is a flowchart showing how to combine storage locations in practice; and

FIG. 4 is a schematic view showing a preferred embodiment of the good picking path.

### DETAILED DESCRIPTION OF THE INVENTION

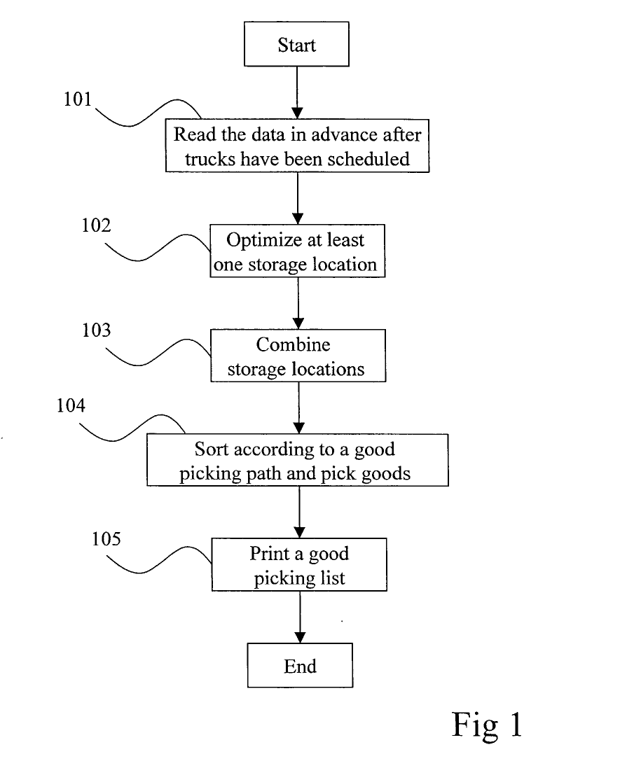

As shown in FIG. 1, after scheduling trucks the data are read in step 101. At that time, each order has been assigned with truck information. Since the stock locations for the order on one truck are obtained by several storage location assignments, the storage locations may be very far apart from one another. The goods on one truck should be picked within a range as small as possible. Through at least one storage location optimization (step 102), the above problem is solved. These step releases all assigned storage locations and then puts locks on the goods for each truck. This ensures that the storage locations for goods on each truck are continuous and thus avoids the problem of picking goods located far away. Step 103 combines the storage locations so that picking the same goods repeatedly at the same storage location is avoided. Goods to be delivered are picked at one time. Step 104 sorts good storage locations according to a good picking path and picks goods. Since the storage locations may be distributed at various corners of the stock, two consecutive good storage locations in a picking list may be far apart. The above steps guarantee that the next good picking location is the one that is closest to the current picking location and the storage locations are provided in the good picking route. Finally, step 105 prints a good picking list.

1. Storage Location Optimization:

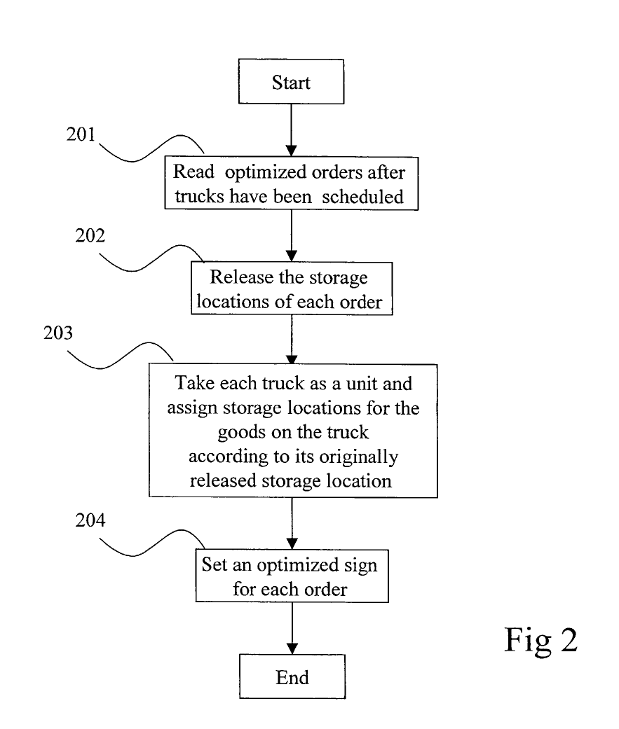

Storage locations are reassigned in the steps described in FIG. 2. First, after scheduling trucks the optimized orders are read in step 201. Storage locations for orders in other statuses are not released. The storage locations on each order are released in step 202. After the storage locations are all released, to ensure the goods on one truck are located at continuous storage locations the storage locations for the goods are reassigned according to the originally released capacity in step 203. Each order is set with an optimization tag in step 204. The optimized order does not need to be optimized again, thus minimizing the number of orders for optimization.

2. Storage Location Combination:

Since one truck may carry items on several orders and the same items may appear on different orders, they may be picked several times at the same storage location. This step combines the same items at the same storage location in different orders so that they are picked at one time.

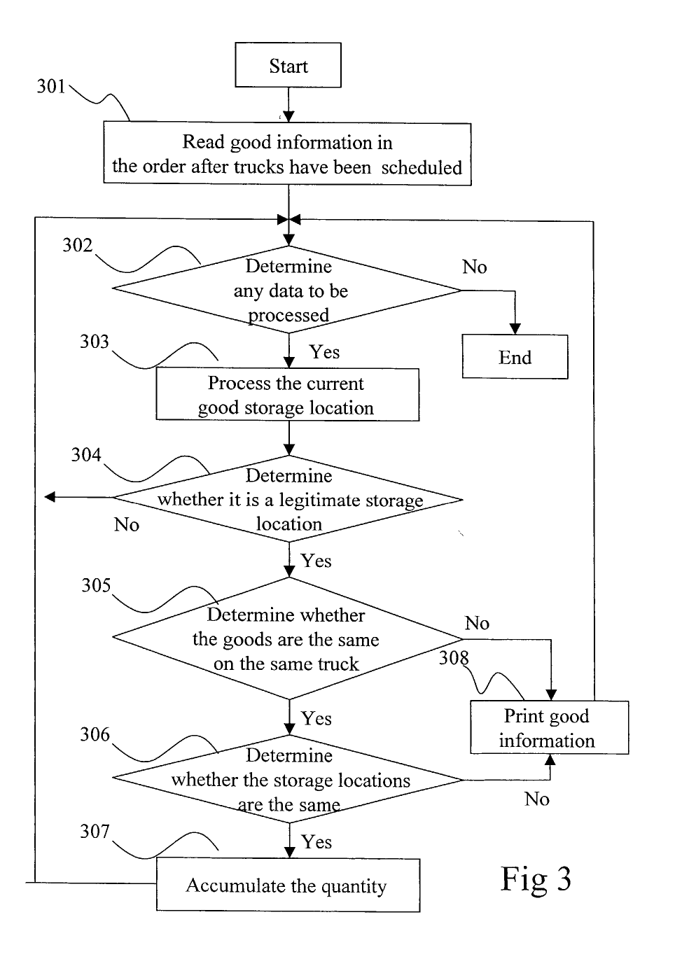

With reference to FIG. 3, after scheduling trucks good data in orders are read in step 301. The good data refer to numbered truck records and sorted good codes. Step 302 determines whether any more data need to be processed. If there are, then the storage locations of the current good is processed in step 303; otherwise, the storage location combination procedure is completed. Step 304 determines whether the storage location is legitimate. If it is illegitimate, then it is not shown on the good picking list and the next good is processed. If it is legitimate, then step 305 determines whether the goods in the storage location are for the same truck. If the goods are for the same truck, step 306 determines whether the storage locations are the same. If they are the same, then the quantity is accumulated in step 307. Otherwise, step 308 prints the good data and processes the next record until the records are completed.

3. Good Picking Path Sorting:

If two consecutive good picking locations are far apart, the distance and the picking time will be too much. To make good picking easier, a good picking route is designed and each storage location on the route has a serial number. When generating the good picking list, the storage locations are sorted according to the serial numbers. This ensures that the distance between two consecutive good picking locations is the shortest. The goods can be conveniently picked out following the route, greatly increasing efficiency.

A preferred embodiment is given below to illustrate the disclosed system and method.

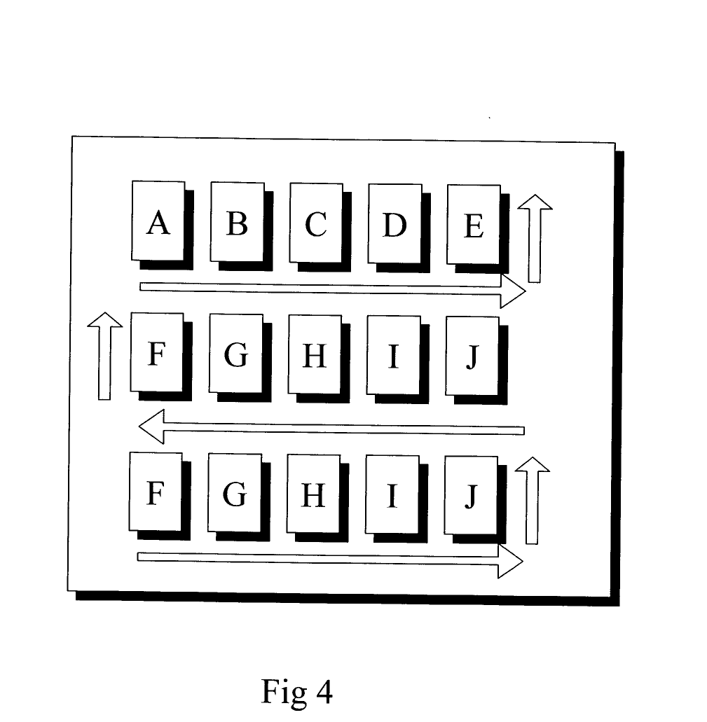

With reference to FIG. 4, two trucks (X and Y) are shipping the same good Z with the goods Z being distributed at storage locations A, B, C, D and E. The goods on truck X are distributed at storage locations A, C and E while those on truck Y at storage locations B and D. Therefore, when picking the goods for truck X, one jumps from storage location A to storage location C and to storage location E, even though the storage locations B and D have the same goods. Such jumps make the good picking path longer. Storage location optimization of the invention solves this problem. First, assigned good storage locations are released and re-assigned for trucks X and Y. Therefore, truck X picks goods at storage locations A, B and C and truck Y picks goods at storage locations D and E. Good picking efficiency is thus increased.

Consider another situation. Suppose storage location A has 50 boxes of good Z and the good picking list has three entries for picking goods at storage location A: A(20), B(20), A(10), C(15), and A(5), where the numbers in the parentheses are the quantities to be picked. One then has to pick the same goods at storage location A three times. The storage location combination step of the invention solves this problem. In these situations, the numbers (quantities) at the same storage location are added together. Thus, the good picking list now becomes: A(35), B(20), and C(15). The goods from storage location A can be picked out at one time.

If the good picking order is K(12), H(4), M(5), J(6), 0(7), and A(8), one can see from the storage location diagram that these consecutive storage locations are far apart. Thus, this order has a longer total distance and the good picking worker has to travel back and forth. If the above order is sorted to become: K(12), M(5), 0(7), J(6), H(4), and A(8), good picking obviously becomes more convenient and efficient.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for simplifying commodity picking management used in optimizing a good picking procedure for production distributions in a stock management system, which comprises the steps of:
reading at least a set of data after scheduling trucks;
performing at least one storage location optimization;
performing storage location combination; and
sorting storage locations according to a good picking path and picking goods.

2. The method of claim 1, wherein the step of performing at least one storage location optimization comprises the steps of:
reading yet optimized orders after scheduling trucks;
releasing storage locations on each of the orders;
re-assigning the storage locations; and
setting an optimization tag for each of the orders.

3. The method of claim 2, wherein the step of re-assigning the storage locations take a truck as a unit and re-assigns the storage locations to the goods on each truck according to the originally released storage capacity.

4. The method of claim 1, wherein the step of performing storage location combination further comprises the steps of:
processing the storage locations of the current good;
ensuring that each of the storage locations is legitimate;
ensuring that the goods stored at the storage locations is on the same truck;
ensuring that the storage locations are the same; and
accumulating the quantity of the good.

5. The method of claim 4 further comprising the step of printing good data.

6. The method of claim 1, wherein the step of sorting storage locations according to a good picking path ensures that the distance between consecutive good picking locations is the shortest one.

7. The method of claim 1 further comprising the step of printing a good picking list.
